(19) United States
(12) Patent Application Publication
(10) Pub. No.: US 2018/0099180 A1
(43) Pub. Date: Apr. 12, 2018

(54) Retractable Caster in an Exercise Machine

(71) Applicant: ICON Health & Fitness, Inc., Logan, UT (US)

(72) Inventor: T. Aaron Wilkinson, Hyde Park, UT (US)

(21) Appl. No.: 15/712,729

(22) Filed: Sep. 22, 2017

Related U.S. Application Data
(60) Provisional application No. 62/407,045, filed on Oct. 12, 2016.

(51) Int. Cl. A63B 22/20; B60B 33/06

(52) U.S. Cl. CPC A63B 22/20; A63B 22/02; B60B 33/06

(57) ABSTRACT

An exercise machine includes a base frame, a movable element that selectively moves with respect to the base frame during a performance of an exercise, and a height adjustable caster assembly connected to the base frame.

### RELATED APPLICATIONS

This application claims priority to U.S. patent application Ser. No. 62/407,045 titled “Retractable Caster in an Exercise Machine” and filed on 12 Oct. 2016, which application is herein incorporated by reference for all that it discloses.

### BACKGROUND

Aerobic exercise is a popular form of exercise that improves one's cardiovascular health by reducing blood pressure and providing other benefits to the human body. Aerobic exercise generally involves low intensity physical exertion over a long duration of time. Typically, the human body can adequately supply enough oxygen to meet the body's demands at the intensity levels involved with aerobic exercise. Popular forms of aerobic exercise include running, jogging, swimming, and cycling, among others activities. In contrast, anaerobic exercise typically involves high intensity exercises over a short duration of time. Popular forms of anaerobic exercise include strength training and short distance running.

Many choose to perform aerobic exercises indoors, such as in a gym or their home. Often, a user will use an aerobic exercise machine to perform an aerobic workout indoors. One type of aerobic exercise machine is a treadmill, which is a machine that has a running deck attached to a support frame. The running deck can support the weight of a person using the machine. The running deck incorporates a conveyor belt that is driven by a motor. A user can run or walk in place on the conveyor belt by running or walking at the conveyor belt's speed. The speed and other operations of the treadmill are generally controlled through a control module that is also attached to the support frame and within convenient reach of the user. The control module can include a display, buttons for increasing or decreasing a speed of the conveyor belt, controls for adjusting a tilt angle of the running deck, or other controls. Other popular exercise machines that allow a user to perform aerobic exercises indoors include elliptical trainers, rowing machines, stepper machines, and stationary bikes to name a few.

One type of treadmill is disclosed in U.S. Pat. No. 6,419,612 issued to Jessica Yu. In this reference, a jogging machine includes a main frame and a jogging seat pivoted to the main frame. The main frame is provided with a plurality of casters in contact with a floor on which the jogging machine is rested. The jogging seat is provided at one end thereof with one or more rollers, which come in contact with the floor at such time when the jogging seat is turned in relation to the base frame to be in an upright position perpendicular to the main frame. The movement of the jogging machine on the floor is made easy by virtue of the casters of the main frame and the rollers of the jogging seat.

### SUMMARY

In one embodiment, an exercise machine includes a base frame, a movable element that selectively moves with respect to the base frame during a performance of an exercise, and a height adjustable caster assembly connected to the base frame.

The height adjustable caster assembly may include a stationary portion, a pivot incorporated into the stationary portion, a pivot arm connected to the stationary portion at the pivot, and a wheel connected to the pivot arm.

The height adjustable caster assembly may include an adjustable urging member connected to the stationary portion that loads a protruding force onto the pivot arm.

The urging member may be a screw member.

The exercise machine may include an opening defined in the stationary portion, and the screw member may be connected to the stationary portion through the opening.

The height adjustable caster assembly may include a return mechanism that imposes a retractable force on the pivot arm.

The urging member may be accessible from the underside of the exercise machine.

The exercise machine may include a motor where the motor is in mechanical communication with the adjustable urging member.

The urging member may be electronically controlled.

The base frame may include a cross member, and the stationary portion of the height adjustable caster assembly is rigidly connected to the cross member.

The exercise machine may include a plate, the plate being connected to the pivot arm and to the wheel, and a second wheel connected to the plate.

The movable element may be a pedal.

The movable element may be a tread belt.

In one embodiment, an exercise machine includes a base frame, a movable element that selectively moves with respect to the base frame during a performance of an exercise, and a height adjustable caster assembly connected to the base frame. The height adjustable caster assembly includes a stationary portion, a pivot incorporated into the stationary portion, a pivot arm connected to the stationary portion at the pivot, a wheel connected to the pivot arm, and an adjustable urging member connected to the stationary portion that loads a protruding force onto the pivot arm.

The height adjustable caster assembly may include a return mechanism that imposes a retractable force on the pivot arm.

The urging member may be accessible from the underside of the exercise machine.

The exercise machine may include a motor where the motor is in mechanical communication with the adjustable urging member.

The urging member may be electronically controlled.

The base frame may include a cross member, and the stationary portion of the height adjustable caster assembly is rigidly connected to the cross member.

In one embodiment, an exercise machine includes a base frame, a cross member being incorporated into the frame, a movable element that selectively moves with respect to the base frame during a performance of an exercise, and a height adjustable caster assembly connected to the base frame. The height adjustable caster assembly includes a stationary portion rigidly connected to the cross member, a pivot incorporated into the stationary portion, a pivot arm connected to the stationary portion at the pivot, a wheel connected to the pivot arm, an adjustable urging member connected to the stationary portion that loads a protruding force onto the pivot arm, and the urging member is accessible from the underside of the exercise machine.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 illustrates a perspective view of an example exercise machine in accordance with the present disclosure.

FIG. 2 illustrates a cut-away perspective view of an example of a height adjustable caster assembly on an exercise machine in accordance with the present disclosure.

FIG. 3 illustrates a cut-away perspective view of an example of a height adjustable caster assembly on an exercise machine in accordance with the present disclosure.

FIG. 4 illustrates a perspective view of an example of a base frame on an exercise machine in accordance with the present disclosure.

FIG. 5 illustrates a cut-away perspective view of an example of a height adjustable caster assembly on an exercise machine in accordance with the present disclosure.

FIG. 6 illustrates a cut-away perspective view of a height adjustable caster assembly on an exercise machine in accordance with the present disclosure.

FIG. 7 illustrates a perspective view of a height adjustable caster assembly in an exercise machine in accordance with the present disclosure.

FIG. 8 illustrates a perspective view of an example of multiple adjustable caster assemblies in an exercise machine in accordance with the present disclosure.

FIG. 9 illustrates a perspective view of an example of an exercise machine in accordance with the present disclosure.

Throughout the drawings, identical reference numbers designate similar, but not necessarily identical, elements.

### DETAILED DESCRIPTION

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. Often, the width of an object is transverse to the object's length.

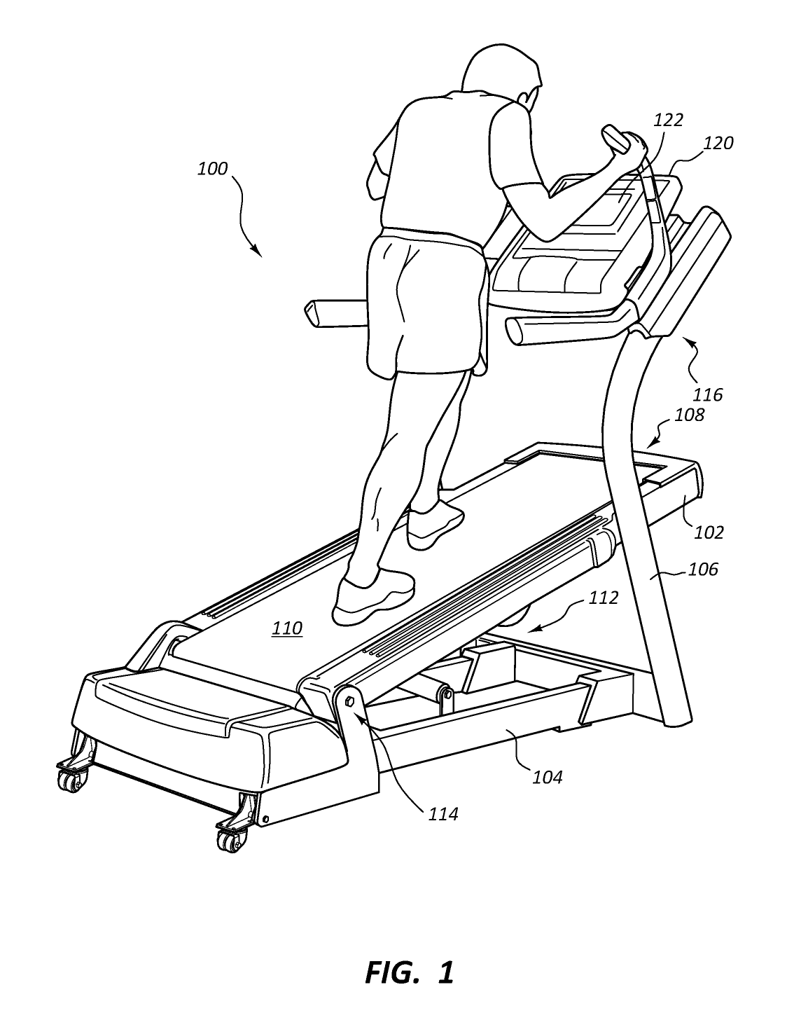

FIG. 1 depicts an example of a treadmill 100 that includes a deck 102, a base 104, and an upright structure 106. The deck 102 includes a platform 108 with a front pulley connected to a front portion of the platform 108, and a rear pulley connected to a rear portion of the platform 108. A tread belt 110 surrounds a portion of the platform, the front pulley, and the second pulley. A motor (not shown) can drive either the front pulley or the rear pulley and cause the tread belt 110 to move along a surface of the platform 108.

An incline mechanism 112 is integrated into the base 104 and controls an elevation of the front portion of the deck 102. The rear portion of the deck is connected to the base 104 at a pivot connection 114. As the incline mechanism raises the front portion of the deck, the rear portion of the deck 102 remains connected to the base 104, thus, the front portion of the deck 102 inclines with respect to the base 104.

The upright structure 106 is connected to the base 104. In this example, the upright structure 106 includes a first post 116 and a second post (obscured from view by the user). The first post 116 and the second post support a console 120. The console 120 includes a display 122.

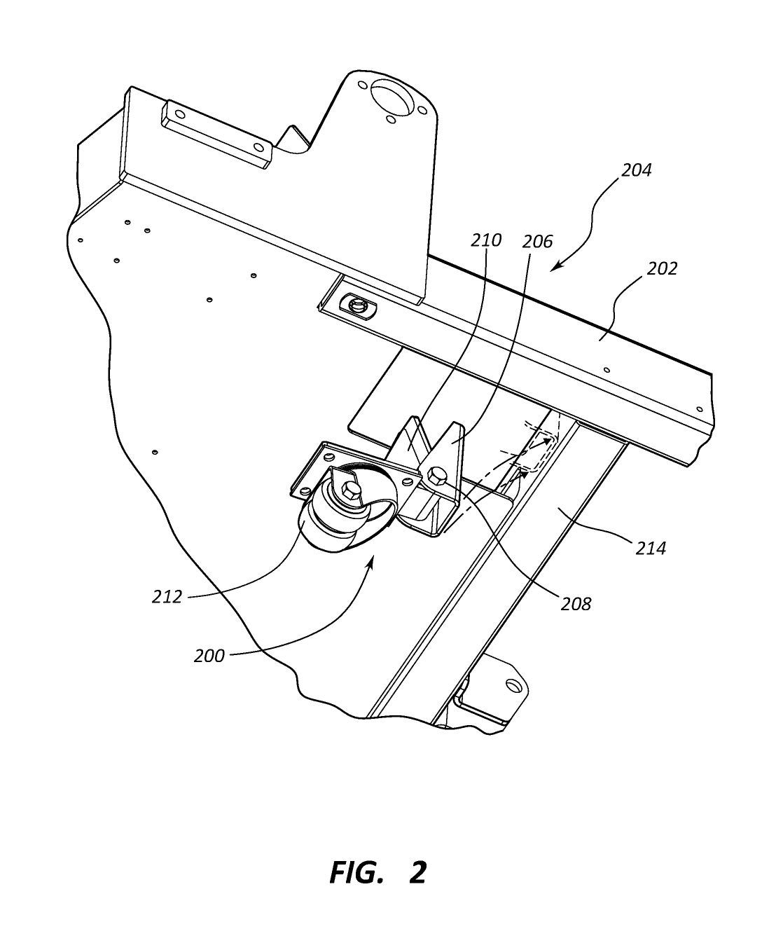

FIG. 2 depicts an example of a height adjustable caster assembly 200. In this example, the height adjustable caster assembly 200 is attached to a frame 202 of the base 204. The height adjustable caster assembly may include a stationary portion 206, a pivot 208 incorporated into the stationary portion 206, a pivot arm 210 connected to the stationary portion 206 at the pivot 208, and a wheel 212 connected to the pivot arm 210. In this example, the base frame 202 includes a cross member 214. The stationary portion 206 of the height adjustable caster assembly 200 is rigidly connected to the cross member 214.

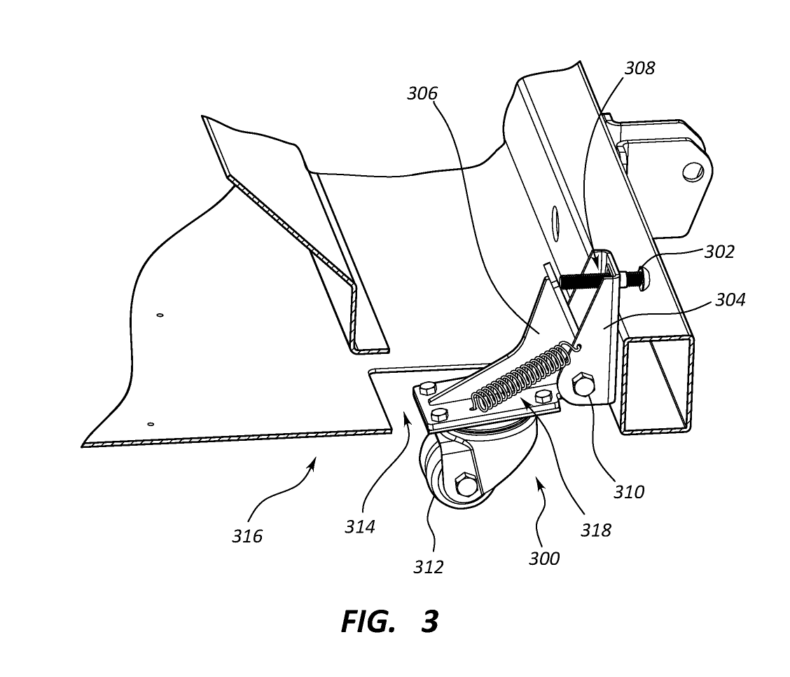

FIG. 3 depicts an example of a height adjustable caster assembly 300. In this example, an adjustable urging member 302 is connected to the assembly's stationary portion 304. The urging member can apply a protruding force onto the assembly's pivot arm 306. In some cases, the urging member 302 is a screw member, which is depicted in FIG. 3. In other examples, the urging member may include an elastomeric material, a spring, a piston, a wedge, a magnet, another type of material, another type of mechanism, or combinations thereof. An opening 308 may be defined in the stationary portion 304, and the urging member 302 is connected to the stationary portion 304 through the opening 308.

The assembly's pivot arm 306 is supported by the pivot 310. When the urging member 302 is fully retracted, the pivot arm 306 has the ability to rotate up to the stationary portion 304 of the assembly 300. In this example, the wheel 312 connected to the pivot arm 306 is pulled up when the pivot arm 306 is fully retracted. In this case, the wheel 312 can be pulled up so that the wheel 312 is retracted into a base opening 314 defined in the base 316, is flush with the opening 314, or is slightly protruding from the opening 314, but does not protrude enough to significantly contact the support surface so that the weight of the exercise machine is loaded to the support surface through the wheel 312. In other examples, the wheels rest on the support surface, but are at least partially pushed up into the base opening 314.

On the other hand, when the urging member 302 is adjusted so that the pivot arm 306 is forced to rotate away from the stationary portion 304 about the pivot 310, the wheel 312 is caused to move through or farther away from the base opening 314. The wheel 312 may move forward enough that the wheel 312 contacts the support surface so that the wheel 312 pushes up on the base 316, and therefore, the exercise machine. In this condition, the wheel 312 loads the weight of the exercise machine to the support surface and lifts the base 316 off of the support surface. With the base at least partially lifted off of the support surface with the height adjustable caster assembly 300, the friction between the exercise machine and the support surface is minimized thereby allowing the user to move the exercise machine more easily across the support surface.

In some examples, the height adjustable caster assembly includes a spring member 318 that imposes a retractable force on the pivot arm. In this example, the urging member may be returned to a retracted position in the absence of a force pushing the pivot arm forward.

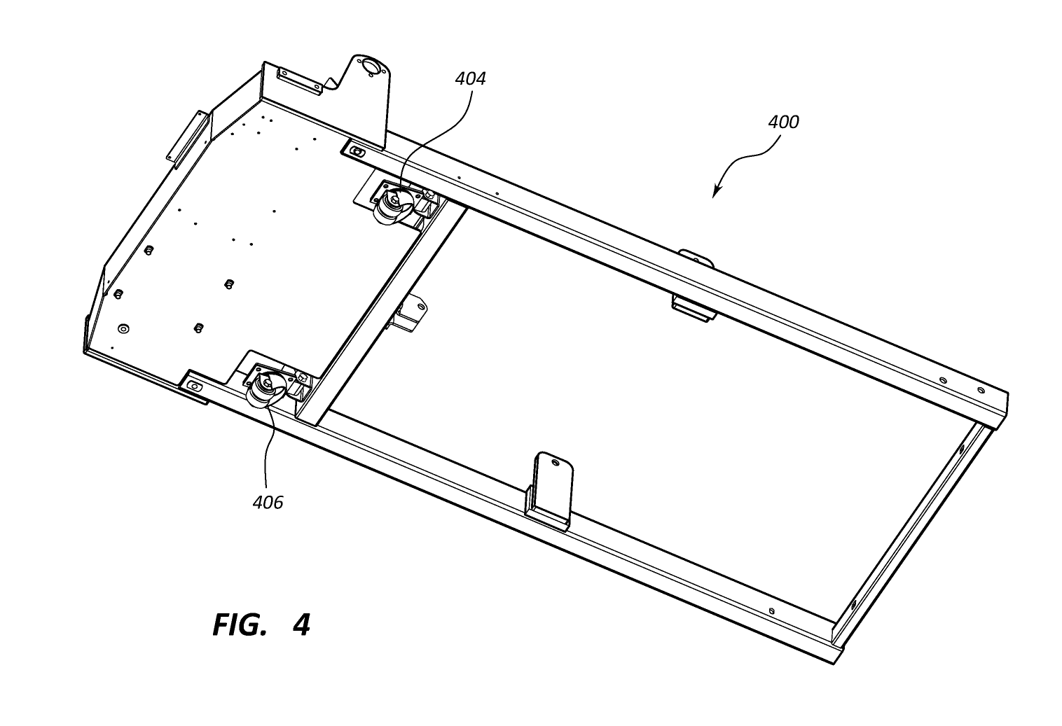

FIG. 4 depicts an example of the underside of the base 400 of the exercise machine. In this example, the exercise machine includes a first height adjustable caster assembly 404 and a second height adjustable caster assembly 406. Each of these caster assemblies 404, 406 may be individually adjusted to either lift the exercise machine for movement across the support surface or to lower the base 400 to stabilize the exercise machine at locations that the user desires. The first and second caster assemblies 404, 406 are located proximate a first side of the base 400. In some examples, the adjustable caster assemblies 404, 406 are located at an end of the base 400 that is proximate the front portion of the exercise machine or the rear portion of the exercise machine. While this example depicts the adjustable casters being proximate at least one end of the exercise machine's base, any of the caster assemblies may be located at any appropriate location along the width or length of the base 400. For example, the caster assemblies may be located at an end of the base, in the middle of the base, near a side of the base, at a midpoint adjacent to the base's side, another location, or combinations thereof.

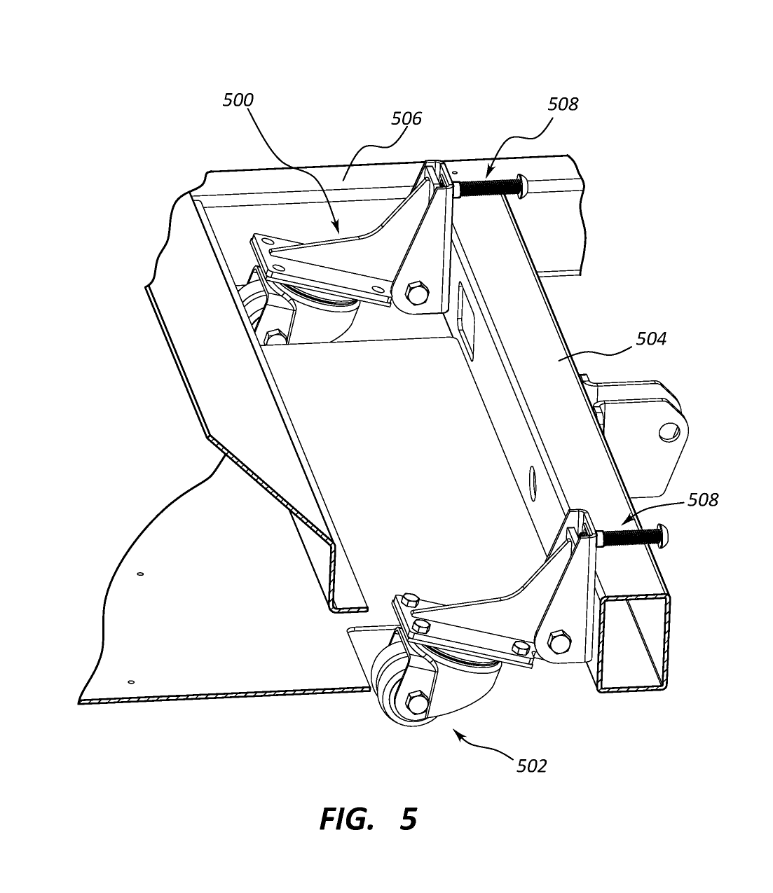

FIG. 5 depicts an example of a first height adjustable caster assembly 500 and a second height adjustable caster assembly 502. Each of the first and second adjustable caster assemblies 500, 502 are connected to a cross member 504 of the base frame 506. Each of the adjustable caster assemblies 502 includes a separate urging member 508. In this example, the urging member 508 is a screw that can be manually adjusted. For example, a user may rotate the screw by engaging the screw head with an Allen wrench, a screwdriver, or another type of tool. In some cases, the urging member 508 is accessible from the underside of the exercise machine. In some examples where the adjustable caster assemblies are incorporated into treadmills, the urging members are accessible when the deck is inclined. While these examples have been described with reference to the urging members being accessible from a specific location, the urging members may be accessible from any appropriate location. For example, the urging members may be accessible from the side of the exercise machine, the top of the exercise machine, another location of the exercise machine, or combinations thereof.

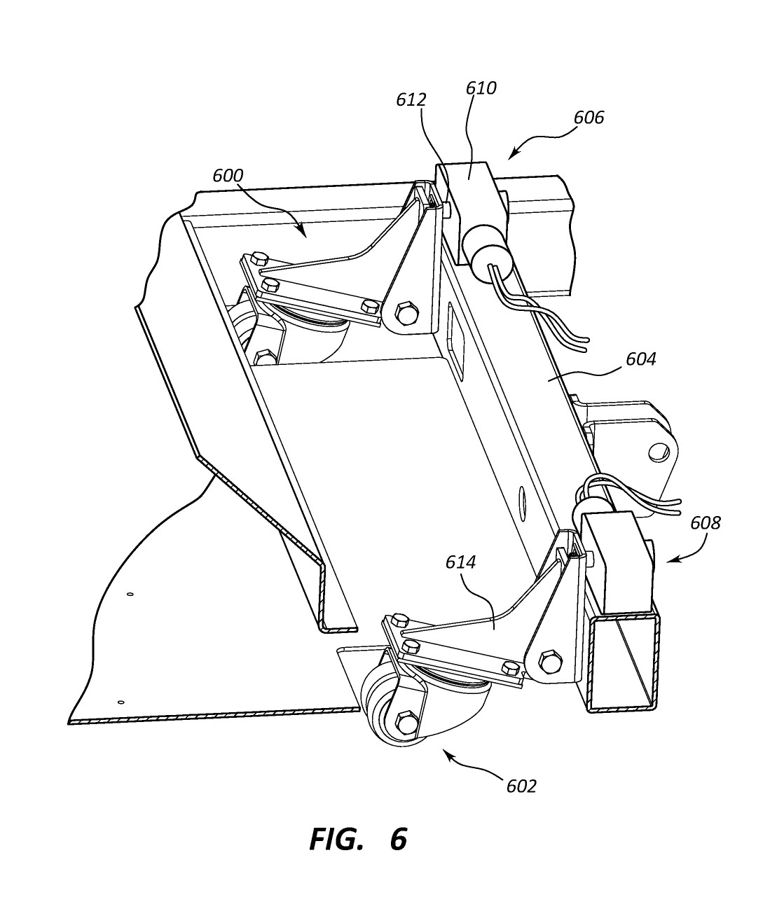

FIG. 6 depicts an example of a first height adjustable caster assembly 600 and a second height adjustable caster assembly 602. Each of the first and second adjustable caster assemblies 600, 602 are connected to a cross member 604 of the base frame 606. Each of the adjustable caster assemblies 600, 602 includes a separate urging member 608. In this example, the urging members 608 include a motor 610 that controls the position of a piston 612. The piston 612 can contact the pivot arm 614 of the adjustable caster assemblies 600, 602.

One advantage to having the motor adjust the position of the wheels is that an input to activate the height adjustable caster assemblies can be incorporated into any appropriate location on the exercise machine. For example, the input to activate the motors may be incorporated into a console, an arm rest, a frame post, another location of the frame, a tread deck, a handle, a seat, an upright structure, another location, or combinations thereof. Thus, the user may not have to access the urging member with a tool to make adjustments to the wheels' height.

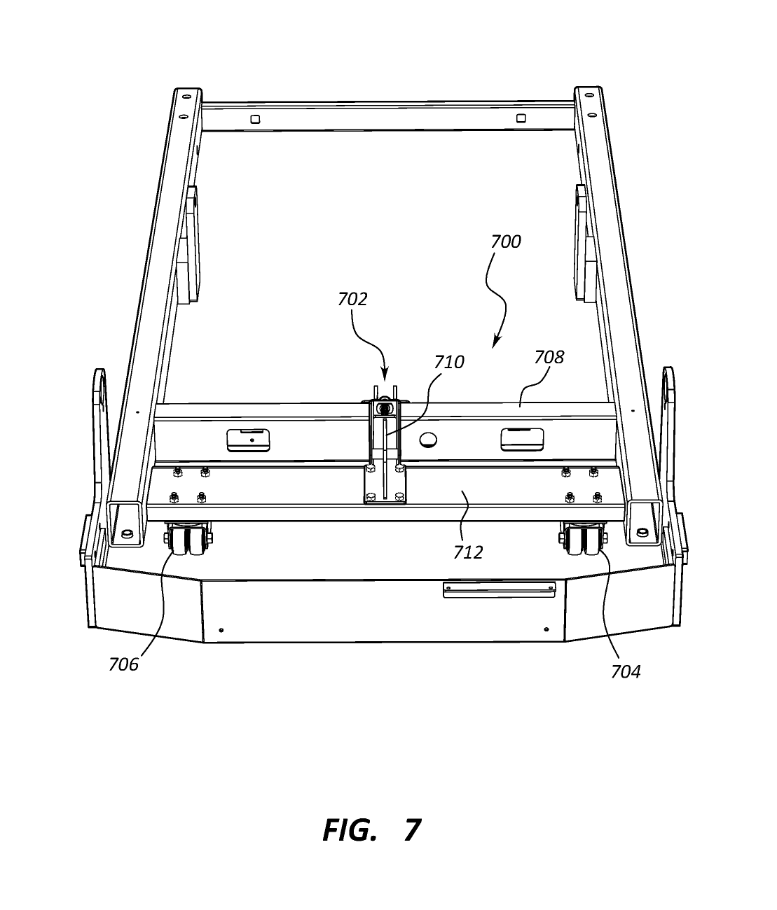

FIG. 7 depicts an example of a height adjustable caster assembly 700 that includes a single urging member 702 that can adjust the position of a first wheel 704 and a second wheel 706. In this example, the urging member 702 is centrally located on the base frame's cross member 708. The pivot arm 710 is movable based on the position of the urging member 702. The pivot arm 710 is attached to a plate 712 that is attached to the first and second wheel 704, 706. As the urging member 702 moves, the plate 712 moves the first and second wheels 704, 706. One benefit to the illustrated example is that the first and second wheels 704, 706 move simultaneously. Thus, the first and second wheels 704, 706 can be consistently at the same level. Further, the user saves the time involved when manually adjusting each of the caster assemblies individually.

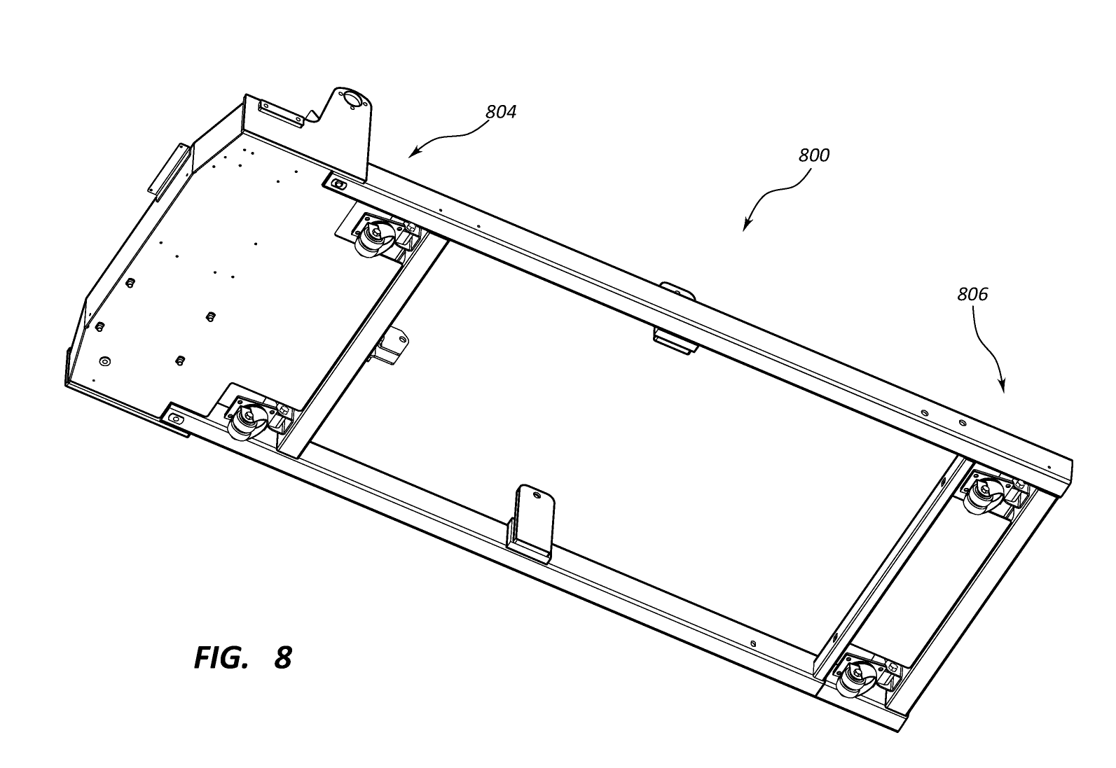

FIG. 8 is an example of a base frame 800 of an exercise machine. In this example, a first set 804 of height adjustable caster assemblies is located proximate a first end of the base frame 800, and a second set 806 of height adjustable caster assemblies is located proximate a second end of the base frame 800. In this example, the user has an option of raising both the first end and the second end of the exercise machine when the user desires to move the exercise machine across the support surface.

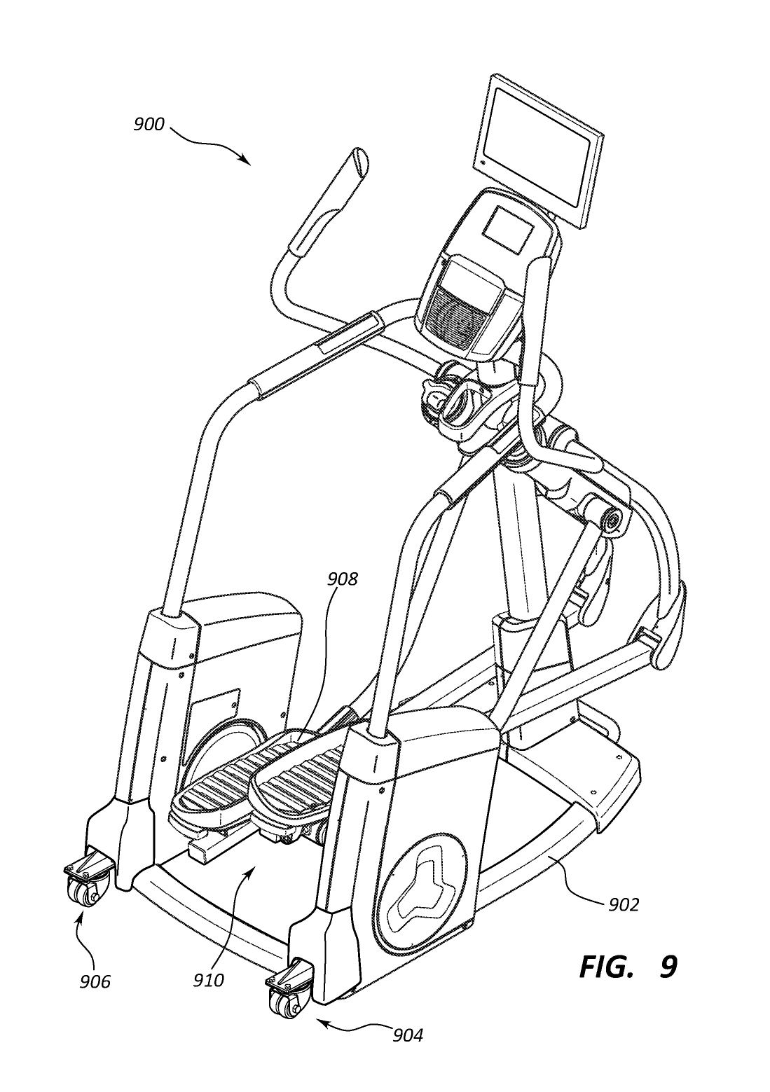

FIG. 9 is an example of an exercise machine 900. In this example, the exercise machine 900 is an elliptical trainer. The exercise machine 900 includes a base frame 902, a first height adjustable caster assembly 904, a second height adjustable caster assembly 906. The first and second height adjustable caster assemblies 904, 906 are connected to the base frame 902. In this example, a pedal 908 is connected to the crank system 910.

### GENERAL DESCRIPTION

In general, the invention disclosed herein may provide users with an exercise machine that has a height adjustable caster assembly. The height adjustable caster assembly allows the user to adjust the position of the caster's wheel so that the wheel engages the support surface (e.g. floor) so that the height adjustable caster assembly becomes weight bearing. Under this condition, the user can more easily move the exercise machine. When desired, the height adjustable caster assembly can be adjusted to cause the caster's wheel to be moved away from the support surface so that the height adjustable caster assembly no longer bears the weight of the exercise machine. As a result, the exercise machine's base frame is engaged with the support surface and thereby increases the difficulty of moving the exercise machine to a different location across the support surface. Thus, the height adjustable caster assembly can decrease the friction of the exercise machine with the support surface when the user desires to move the exercise machine and increase the friction between the exercise machine and the support surface when the user desires the exercise machine to be more stable. For example, the user may desire the exercise machine to be more stable when the user is performing an exercise on the exercise machine.

In some examples, the exercise machine is a treadmill. The treadmill may include an exercise deck. The exercise deck may include a platform that has a first pulley located in a front portion of the deck and a second pulley located in a rear portion of the deck. A tread belt may surround the first and second pulleys and provide a surface on which the user may exercise. At least one of the first pulley and the second pulley may be connected to a motor so that when the motor is active, the pulley rotates. As the pulley rotates, the tread belt moves as well. The user may exercise by walking, running, or cycling on the tread belt's moving surface. In other examples, the tread belt is moved with the user's own power.

The exercise deck may be capable of having its front portion raised and lowered as well as its rear portion raised and lowered to control the lengthwise slope of the running deck. With these elevation controls, the orientation of the running deck can be adjusted as desired by the user or as instructed by a programmed workout.

In some cases, the treadmill includes an upright structure and a console connected to the upright structure. The console may include a display, an input mechanism for controlling various features and/or operational controls of the treadmill, an energy efficiency indicator, a speaker, a fan, another component of the treadmill, or combinations thereof.

The console may locate the input mechanism within a convenient reach of the user to control the operating parameters of the exercise deck. For example, the control console may include controls to adjust the speed of the tread belt, adjust a volume of a speaker integrated into the treadmill, adjust an incline angle of the running deck, adjust a decline of the running deck, adjust a lateral tilt of the running deck, select an exercise setting, control a timer, change a view on a display of the control console, monitor the user's heart rate or other physiological parameters during the workout, perform other tasks, or combinations thereof. Buttons, levers, touch screens, voice commands, or other mechanisms may be incorporated into the console incorporated into the treadmill and can be used to control the capabilities mentioned above. Information relating to these functions may be presented to the user through the display. For example, a calorie count, a timer, a distance, a selected program, an incline angle, a decline angle, a lateral tilt angle, another type of information, or combinations thereof may be presented to the user through the display.

The deck may be attached to a base. In some cases, the base includes a base frame that includes a first longitudinal frame member and a second longitudinal frame member that is aligned with the first longitudinal frame member. The first and second longitudinal frame members may be connected to each other through at least one cross member. In some cases, a forward cross member connects the first and second longitudinal frame members within a front portion of the frame. In some examples, a rearward cross member connects the first and second longitudinal frame members in a rear portion of the base. The base frame may have any appropriate number of longitudinal frame members and any appropriate number of cross members. The deck may be pivotally attached to a portion of the base. In some cases, a rearward end of the deck is pivotally attached to the base.

An incline mechanism may be used to raise and/or lower the front portion of the deck. In some embodiments, as the front portion of the deck is raised and lowered, the slope of the exercise deck changes as the rear portion of the deck remains pivotally connected to the base. Any appropriate type of incline mechanism may be used in accordance with the principles described in the present disclosure. The incline mechanism may include a retractable cylinder that has a first end connected to the deck and a second end attached to the base. The cylinder may extend to elevate the front portion of the deck or retract to lower the front portion of the deck. In some examples, multiple cylinders are used to raise and lower the front portion of the deck. These cylinders may operate simultaneously or sequentially to raise and/or lower the front portion of the deck. Further, at least one cylinder used to raise and lower the front portion of the deck may be a multi-stage cylinder or a single stage cylinder.

In another embodiment, a portion of the incline mechanism is incorporated into the upright structure. In one of these types of examples, a track may be incorporated into at least one of the first post and the second post of the upright structure. The portion of the deck may be connected to posts and movable within the tracks of the posts. In one case, the track may be rack, and a pinion is attached to the deck. As the pinions rotate, the track moves in accordance with the direction that the pinion is rotating. In another example, the front portion of the track may be connected to posts through a cable that is spooled about a winch. As the winch unwinds, the incline mechanism lowers the front portion of the deck. Conversely, as the winch winds up the cable, the front portion of the track is lifted.

A belt motor may be used to move the treadmill's belt. The belt motor may be located in any appropriate location on the treadmill. For example, the belt motor may be located proximate the first pulley or the second pulley. The belt motor may drive the rotation of at least one of the pulleys to cause the tread belt to move. In some cases, the motor is connected to the pulley through a transmission belt, a gear set, another transmission mechanism, or combinations thereof. The belt motor may be located in the base and connect to the rear pulley in those situations where the rear pulley shares a rotational axis with the pivot connection attaching the deck to the base. In other examples, the belt motor may be located in the deck with the pulley. One advantage to having the belt motor in the base is that the belt motor's weight can contribute to the weight of the base to stabilize the treadmill and the incline mechanism has less weight to support as it raises and lowers the front portion of the deck.

In other examples, the exercise machine may be a stationary bicycle, an elliptical trainer, a rowing machine, a pull cable machine, another type of exercise machine, or combinations thereof. In some examples, where the exercise machine includes a resistance mechanism that may be attached to a frame. A crank assembly may be in mechanical communication with the resistance mechanism. The crank assembly may include a crank arm and a pedal assembly movably attached to the crank assembly and movable in the performance of an exercise. In some examples, the resistance mechanism is a flywheel with a magnetic mechanism that resists the movement of the flywheel. In other examples, the resistance mechanism includes a plate stack where at least some of the plates are selectively connected to a cable. When at least one plate is connected to the cable, the user may pull a handle on the other end of the cable to lift the connected weight plate.

In some examples, the exercise machine, regardless of the type of machine, includes a height adjustable caster assembly. The height adjustable caster assembly may be attached to a frame of the base. The height adjustable caster assembly may include a stationary portion, a pivot incorporated into the stationary portion, a pivot arm connected to the stationary portion at the pivot, and a wheel connected to the pivot arm. In some cases, the base frame may include a cross member, and the stationary portion of the height adjustable caster assembly may be rigidly connected to the cross member.

The adjustable urging member may be connected to the assembly's stationary portion. The urging member may load a protruding force onto the assembly's pivot arm. In some cases, the urging member is a screw member. In other examples, the urging member may include an elastomeric material, a spring, a piston, a wedge, a magnet, another type of material, another type of mechanism, or combinations thereof. An opening may be defined in the stationary portion, and the urging member is connected to the stationary portion through the opening.

The assembly's pivot arm may be supported by the pivot. When the urging member is fully retracted, the pivot arm may have the ability to rotate up to the stationary portion of the caster assembly. In this example, the wheel connected to the pivot arm is pulled up when the pivot arm is fully retracted. In some cases, the wheel can be pulled up so that the wheel is retracted into a base opening defined in the base, is flush with the opening, or just slightly protrudes from the opening, but does not protrude enough to significantly contact the support surface so that the weight of the exercise machine is loaded to the support surface through the wheel. In other examples, no force is applied to the wheels allowing the wheels to contact the support surface, but without a force that causes the wheels to lift the exercise machine.

On the other hand, when the urging member is adjusted so that the pivot arm is forced to rotate away from the stationary portion about the pivot, the wheel may be caused to move through or farther away from the base opening. The wheel may move forward enough that the wheel contacts the support surface so that the wheel pushes up on the base, and therefore, the exercise machine. In this condition, the wheel may load the weight of the exercise machine to the support surface and lift the base off of the support surface. With the base at least partially lifted off of the support surface with the height adjustable caster assembly, the friction between the exercise machine and the support surface may be reduced thereby allowing the user to move the exercise machine more easily across the support surface.

In some examples, the height adjustable caster assembly includes a return mechanism that imposes a retractable force on the pivot arm. The return mechanism may include a spring, a pneumatic mechanism, a magnetic mechanism, a hydraulic mechanism, an elastomeric material, another type of return mechanism, or combinations thereof. In this example, the urging member may be returned to a retracted position in the absence of a force pushing the pivot arm forward.

In some cases, the exercise machine includes more than one height adjustable caster assembly. In some of these cases, the height of each of these caster assemblies may be individually adjusted. The height of the caster assemblies may be adjusted to either lift the exercise machine off of the support surface so that the exercise machine may move across the support surface. In other situations, the height of the caster assemblies may be changed to lower the base. In those circumstances where the base is lowered into the support surface by retracting the caster's wheels, the base may increase its contact area with the support surface. The increased contact area may include the friction between the support surface and the exercise machine thereby making movement between the support surface and the exercise machine more difficult, which can increase the exercise machine's stability. The user may desire the increased stability when the exercise machine is in the location where the user desires to exercise. The increased stability may be desired as the user gets on and off of the exercise machine. However, the increased stability may make moving the exercise machine more difficult. Thus, with the present system, the user may position the casters' wheels to lift at least a portion of the exercise machine off of the support surface so that the exercise machine can be moved. When the user is performing an exercise, the user may retract the caster assembly so that the load on the casters' wheels are reduced and the exercise machine becomes more stable.

In some cases, a first caster assembly and a second caster assembly are located proximate a first side of the exercise machine, such as the front portion of the exercise machine or the rear portion of the exercise machine. However, the caster assemblies may be located at any appropriate location of the base. For example, the caster assemblies may be located at an end of the base, in the middle of the base, near a side of the base, at a midpoint adjacent to the base's side, another location, or combinations thereof. Further, the height adjustable caster assemblies may be attached to any component of the base frame. For example, the caster assemblies may be attached to a longitudinal member of the base frame, a cross member of the base frame, another portion of the base frame, or combinations thereof. In those instances where the base includes a panel that is attached to the frame, the wheel of the caster assembly may move through a cutout or another type of opening defined in the panel when the height of the wheel is being adjusted.

Each of the adjustable caster assemblies may include a separate urging member. The urging member may be a screw that is threadedly engaged in an opening defined in the stationary portion of the caster assembly. As the screw is rotated in a first direction, the screw may advance along its length through the opening and a contact end of the urging member may push the pivot arm forward. When the screw is rotated in a second direction that is opposite the first direction, the screw may move along its length in an opposite direction that moves the contact end back towards the caster assembly's stationary portion. In some cases, the contact end of the urging member is attached to the pivot arm so that when the contact end of the urging member moves back towards the stationary member, the pivot arm moves with the contact end. For example, the screw member may have a rotary connection with the pivot arm that allows the screw to rotate independently of the pivot arm, but causes the pivot arm to move as the screw translates along its length.

In an alternative example, the contact end of the urging member comes into contact with the pivot arm, but does not have a mechanical attachment to the pivot arm. Thus, the retracting movement of the contact end does not directly cause the pivot arm to rotate about its axis to cause the wheel to retract away from the support surface. However, the retracting motion of the urging member does remove the force imposed on the caster assembly pivot arm to push the wheel against the support surface and thereby allows the wheel to be pushed up by the support surface in the absence of a force from the urging member. Thus, when retracting of the urging member, the support surface may push up the wheel and therefore the pivot arm. Under this condition, the wheel is not load bearing because the urging member is retracted, thus, the wheels move up without lifting the base frame of the exercise machine. In yet another example, an active mechanism may be used to retract the caster assemblies' wheels.

In some examples where the urging member is a screw and the screw can be manually adjusted, a user may rotate the screw by engaging the screw head with an Allen wrench, a screwdriver, or another type of tool. In some cases, the urging member is accessible from the underside of the exercise machine. Additionally, some embodiments where the adjustable caster assemblies are incorporated into treadmills, the urging members are accessible from above the base frame when the deck is inclined. While these examples have been described with reference to the urging members being accessible from specific locations, the urging members may be accessible from any appropriate location. For example, the urging members may be accessible from the side of the exercise machine, the top of the exercise machine, another location of the exercise machine, or combinations thereof.

In other examples, the height adjustable casters are electronically controlled. In one type of these examples, the urging member may be moved by a motor. In those examples where the urging member is a screw, a motor may rotate the screw in either the first direction to force the wheel against the support surface or in a second direction to allow the wheel to retract. In yet another example, the urging member may include a solenoid that has a piston positioned to move the pivot arm.

In those embodiments where the caster assemblies are controlled electronically, the input that controls the caster assembly can be located in any appropriate location on the exercise machine or off of the exercise machine. One advantage to having the motor adjust the position of the wheels is that an input to activate the adjustable caster assemblies can be incorporated into any appropriate location on the exercise machine. For example, the input to activate the motors may be incorporated into a console, an arm rest, a frame post, another location of the frame, a tread deck, a handle, a seat, an upright structure, another location, or combinations thereof. Thus, the user may not have to access the urging member with a tool to make adjustments to the wheels' positions. In some cases, the motors may be activated through speech commands.

In some cases, a single urging member is common to multiple wheels. For example, the urging member may be centrally located (or located off center) on the base frame's cross member and control the position of a pivot arm that is attached to a plate. Multiple wheels may be attached to the plate so that as the pivot moves, the plate moves and the wheels move with the plate. One benefit to having multiple wheels positioned with a single urging member is that the first and second wheels move simultaneously. This allows the wheels to be loaded evenly during the process of raising and lowering the exercise machine. For example, if the two wheels are raised and lowered simultaneously, each of the wheels can bear half the weight of the portion of the exercise machine lifted by the caster assemblies. Thus, a wider range of wheel types, wheel sizes, and wheel materials may be used to construct the caster assemblies. Further, the first and second wheels can be consistently at the same level, which prevents the exercise machine from being oriented at an tilt angle thereby unevenly loading the wheels. Additionally, in those examples where the urging member is raised and lowered manually, the user saves the time involved with manually adjusting each of the caster assemblies separately.

The height adjustment caster assemblies may include a combination of hardware and programmed instructions for executing the functions of the height adjustment caster assemblies. The height adjustment caster assemblies may include processing resources that are in communication with memory resources. Processing resources include at least one processor and other resources used to process the programmed instructions. As described herein, the memory resources may represent generally any memory capable of storing data such as programmed instructions or data structures used by the height adjustment caster assemblies.

The processing resources may include I/O resources that are capable of being in communication with a remote device that stores the user information, workout history, external resources, databases, or combinations thereof. The remote device may be a mobile device, a cloud based device, a computing device, another type of device, or combinations thereof. In some examples, the height adjustment caster assemblies communicate with the remote device through a mobile device which relays communications between the height adjustment caster assemblies and the remote device. In other examples, the mobile device has access to information about the user.

The remote device may execute a program that can provide useful information to the height adjustment caster assemblies. An example of a program that may be compatible with the principles described herein includes the iFit program which is available through www.ifit.com. An example of a program that may be compatible with the principles described in this disclosure is described in U.S. Pat. No. 7,980,996 issued to Paul Hickman. U.S. Pat. No. 7,980,996 is herein incorporated by reference for all that it discloses. In some examples, the user information accessible through the remote device includes the user's age, gender, body composition, height, weight, health conditions, other types of information, or combinations thereof.

The processing resources, memory resources, and remote devices may communicate over any appropriate network and/or protocol through the input/output resources. In some examples, the input/output resources includes a transmitter, a receiver, a transceiver, or another communication device for wired and/or wireless communications. For example, these devices may be capable of communicating using the ZigBee protocol, Z-Wave protocol, BlueTooth protocol, Wi-Fi protocol, Global System for Mobile Communications (GSM) standard, another standard, or combinations thereof. In other examples, the user can directly input some information into the pacing mechanism through a digital input/output mechanism, a mechanical input/output mechanism, another type of mechanism, or combinations thereof.

The memory resources may include a computer readable storage medium that contains computer readable program code to cause tasks to be executed by the processing resources. The computer readable storage medium may be a tangible and/or non-transitory storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, magnetic based memory, other types of memory, or combinations thereof.

The memory resources may include an input recognition, which represents programmed instructions that cause the processor to recognize when a user has sent a command to the urging member. The input recognition may determine which direction to move the urging member based on the user's commands. In some cases, the memory resources include inputs from sensors that indicate whether the user is still on the exercise machine. In some examples that include a sensor to communicate whether the user is still on the exercise machine, the programmed instructions may include a policy that prevents the urging member from pushing the wheels against the support surface. In this type of situation, the user's body weight may increase the force needed to lift the exercise machine. In this case, the urging member may be activated on just those occasions where the user is off of the exercise machine, and the caster assemblies may be constructed for applying a consistent load that does not include a user's weight. In other examples, the caster assembly may apply a proportional load to the urging members depending on the amount of weight that the sensors detect on the exercise machine. While these examples have been described with specific programmed instructions, any appropriate type of programmed instructions may be used to adjust a force of the urging member, to coordinate the movement of multiple urging members, improve safety as the urging members are deployed, to provide other benefits, and combinations thereof.

Further, the memory resources may be part of an installation package. In response to installing the installation package, the programmed instructions of the memory resources may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources and the memory resources are located within the exercise machine, a mobile device, an external device, another type of device, or combinations thereof. The memory resources may be part of any of these device's main memory, caches, registers, non-volatile memory, or elsewhere in their memory hierarchy. Alternatively, the memory resources may be in communication with the processing resources over a network. Further, data structures, such as libraries or databases containing user and/or workout information, may be accessed from a remote location over a network connection while the programmed instructions are located locally.

While the examples above have been described with reference to a specific number of caster assemblies and/or wheels, any appropriate number of caster assemblies and/or wheels may be used in accordance with the present disclosure. Also, any appropriate type of height adjustable caster assembly may be used in accordance with the present disclosure. For example, the urging member may be positioned to apply a substantially vertical force on the wheels with respect to the base frame, a pivot force on the wheels with respect to the base frame, a substantial horizontal force on the wheels with respect to the base frame, apply a force on the wheels from another appropriate direction, or combinations thereof.

What is claimed is:

1. An exercise machine, comprising:
a base frame;
a movable element configured to selectively move with respect to the base frame during a performance of an exercise; and
an height adjustable caster assembly connected to the base frame.

2. The exercise machine of claim 1, wherein the height adjustable caster assembly further comprises:
a stationary portion;
a pivot incorporated into the stationary portion;
a pivot arm connected to the stationary portion at the pivot; and
a wheel connected to the pivot arm.

3. The exercise machine of claim 2, wherein the height adjustable caster assembly further comprises an adjustable urging member connected to the stationary portion;
wherein the adjustable urging member is configured to load a protruding force onto the pivot arm.

4. The exercise machine of claim 3, wherein the urging member is a screw member. The exercise machine of claim 4, further comprising:
an opening defined in the stationary portion;
wherein the screw member is connected to the stationary portion through the opening.

6. The exercise machine of claim 3, wherein the height adjustable caster assembly further comprises a return mechanism configured to impose a retractable force on the pivot arm.

7. The exercise machine of claim 3, wherein the urging member is accessible from an underside of the exercise machine.

8. The exercise machine of claim 3, further comprising:
a motor;
wherein the motor is in mechanical communication with the adjustable urging member.

9. The exercise machine of claim 3, wherein the urging member is electronically controlled.

10. The exercise machine of claim 2, wherein the base frame comprises a cross member; and
wherein the stationary portion of the height adjustable caster assembly is rigidly connected to the cross member.

11. The exercise machine of claim 2, further comprising:
a plate; and
a second wheel connected to the plate;
wherein the plate is connected to the pivot arm and to the wheel.

12. The exercise machine of claim 1, wherein the movable element comprises a pedal.

13. The exercise machine of claim 1, wherein the movable element comprises a tread belt.

14. An exercise machine, comprising:
a base frame;
a movable element configured to selectively move with respect to the base frame during a performance of an exercise; and
a height adjustable caster assembly connected to the base frame, wherein the height adjustable caster assembly further includes:
a stationary portion;
a pivot incorporated into the stationary portion;
a pivot arm connected to the stationary portion at the pivot;
a wheel connected to the pivot arm; and
an adjustable urging member connected to the stationary portion configured to selectively load a protruding force onto the pivot arm.

15. The exercise machine of claim 14, wherein the height adjustable caster assembly further comprises a return mechanism configured to impose a retractable force on the pivot arm.

16. The exercise machine of claim 14, wherein the urging member is accessible from an underside of the exercise machine.

17. The exercise machine of claim 14, further comprising:
a motor;
wherein the motor is in mechanical communication with the adjustable urging member.

18. The exercise machine of claim 14, wherein the urging member is electronically controlled.

19. The exercise machine of claim 14, wherein the base frame comprises a cross member; and
wherein the stationary portion of the height adjustable caster assembly is rigidly connected to the cross member.

20. An exercise machine, comprising:
a base frame;
a cross member being incorporated into the base frame;
a movable element configured to selectively move with respect to the base frame during a performance of an exercise; and
a height adjustable caster assembly connected to the base frame, the height adjustable caster assembly further includes:
a stationary portion rigidly connected to the cross member;
a pivot incorporated into the stationary portion;
a pivot arm connected to the stationary portion at the pivot;
a wheel connected to the pivot arm; and
an adjustable urging member connected to the stationary portion that selectively loads a protruding force onto the pivot arm;
wherein the urging member is accessible from an underside of the exercise machine.
